(19) United States
(12) Patent Application Publication
(10) Pub. No.: US 2021/0018906 A1
(43) Pub. Date: Jan. 21, 2021

(54) Feature Value Extraction Apparatus, Predicted-Failure-Evidence Diagnosis Apparatus, Design Assistance Apparatus, and Predicted-Failure-Evidence Diagnosis Operation Method

(71) Applicant: Hitachi, Ltd., Chiyoda ku, Tokyo (JP)

(72) Inventors: Munetoshi UNUMA, Tokyo (JP); Akihiro KOMASU, Tokyo (JP)

(21) Appl. No.: 17/043,209

(22) PCT Filed: May 10, 2019
(86) PCT No.: PCT/JP2019/018660

§ 371 Date: Sep. 29, 2020

(30) Foreign Application Priority Data
May 31, 2018 (JP) 2018-104429

(51) Int. Cl. G05B 23/02

(52) U.S. Cl. CPC G05B 23/0283; G06F 3/14

(57) ABSTRACT

Provided are a feature amount extraction device, a failure sign diagnosis device, a design assistance device, and a failure sign diagnosis operation method which are suitable for predictively diagnosing equipment failure. The feature amount extraction device is for acquiring data from a sensor attached to a piece of equipment to be diagnosed and outputting a feature amount after pre-processing is executed, and is characterized by being provided with: a reconfigurable circuit to which the data from the sensor is inputted; an arithmetic unit; a reconfigured information database that stores reconfigured information; and a communication module for external connection, wherein the arithmetic unit outputs, through the communication module, the feature amount acquired by executing a feature amount extraction process and the pre-processing using the reconfigurable circuit performed with respect to the data from the sensor, stores the reconfigured information acquired from the outside in the reconfigured information database, and configures the reconfigurable circuit in accordance with the reconfigured information.

### TECHNICAL FIELD

The present invention relates to a feature value extraction apparatus, a predicted-failure-evidence diagnosis apparatus, a design assistance apparatus, and a predicted-failure-evidence diagnosis operation method suitable for predictively diagnosing apparatus failure.

### BACKGROUND ART

PTL 1 is known as a technique for predictively diagnosing apparatus failure. PTL 1 has an object to provide an abnormality predictor diagnosis apparatus or the like that can diagnose the presence or absence of an abnormality predictor with high accuracy of mechanical equipment, and it is configured that “The abnormality predictor diagnosis apparatus 1 includes: a sensor data acquisition means 12 for acquiring sensor data including the detection value of the sensor installed in the mechanical equipment 2, a learning means for setting sensor data in a period in which the mechanical equipment 2 is known to be normal as a learning target, and for learning a time-series waveform of the sensor data as a normal model, and a diagnostic means for diagnosing the presence or absence of an abnormality predictor of the mechanical equipment 2 based on the comparison between the normal model and the time-series waveform of the sensor data on a diagnosis target”.

### CITATION LIST

### Patent Literature

PTL 1: JP 2017-33471 A

### SUMMARY OF INVENTION

### Technical Problem

PTL 1 describes that the harmonics included in the learning data are attenuated by a filter to suppress extraction of an unnecessarily large number of feature points.

As described in PTL 1, usually, to remove a noise signal which affects an unnecessarily large number of feature points (hereinafter, to unify the wording, characteristic physical quantities required for diagnosis including feature points are set as feature values) and which affects feature value extraction performance, filtering processing is performed. Optimal filtering processing is required to remove an appropriate amount of feature value and noise signals.

Therefore, if the filtering processing is mistaken, the feature value may not be observed at all, the noise signal may not be removed sufficiently, or the signal component important for the feature value extraction may be removed. Therefore, the detection performance of a feature value is degraded, which may cause a false alarm or alarm failure in the predictor diagnosis. It should be noted that the types and characteristics of noise signals and the characteristics of filtering processing that narrows down to an appropriate amount of feature values often differ depending on the machine to be diagnosed and the installed site environment, and in many cases, it is difficult to determine in advance the processing content of preprocessing and the parameter settings of preprocessing.

Therefore, in the preprocessing of feature value detection such as filtering processing, it is necessary to select the optimum preprocessing method while checking the characteristics of the collected data before processing, but PTL 1 does not describe these.

From this, it is an object of the present invention to provide a feature value extraction apparatus, a predicted-failure-evidence diagnosis apparatus, a design assistance apparatus, and a predicted-failure-evidence diagnosis operation method suitable for predictively diagnosing apparatus failure.

### Solution to Problem

From the above, the present invention includes “a feature value extraction apparatus configured to obtain data from a sensor attached to a diagnosis target apparatus to output a feature value after preprocessing, the feature value extraction apparatus including: a reconfigurable circuit configured to input data from the sensor; an arithmetic unit; a reconfiguration information database configured to store reconfigured information; and a communication module for external connection. The arithmetic unit outputs, to an outside by communication module, a feature value obtained by performing, on data from the sensor, preprocessing and feature value extraction processing using the reconfigurable circuit, stores reconfiguration information obtained from an outside in the reconfiguration information database, and configures the reconfigurable circuit according to the reconfiguration information.”

In addition, the present invention includes “a predicted-failure-evidence diagnosis processing apparatus including a predicted-failure-evidence diagnosis processing unit configured to diagnose the diagnosis target apparatus using a feature value from the feature value extraction apparatus.”

In addition, the present invention includes “a design assistance apparatus including: determining configuration of the reconfigurable circuit using a feature value from the feature value extraction apparatus; and sending the configuration to the feature value extraction apparatus as the reconfiguration information via the communication module.”

In addition, the present invention includes “a predicted-failure-evidence diagnosis operation method including: connecting, to a design assistance apparatus, a feature value extraction apparatus including: a reconfigurable circuit configured to input data from a sensor attached to a diagnosis target apparatus, and a reconfiguration information database configured to store reconfiguration information, the feature value extraction apparatus configured to change a configuration of the reconfigurable circuit according to the reconfiguration information; in the design assistance apparatus, determining a configuration of the reconfigurable circuit using a feature value from the feature value extraction apparatus, sending the configuration to the feature value extraction apparatus as the reconfiguration information, and storing the configuration in a reconfiguration information database; and separating the feature value extraction apparatus from the design assistance apparatus, and connecting to a predicted-failure-evidence diagnosis processing apparatus configured to diagnose the diagnosis target apparatus using a feature value from the feature value extraction apparatus instead.”

### Advantageous Effects of Invention

According to the present invention, it is possible to incorporate the optimum processing content required for preprocessing into the feature value detection means, and it is possible to provide a predicted-failure-evidence diagnosis apparatus and an apparatus with high detection performance.

### BRIEF DESCRIPTION OF DRAWINGS

FIG. 1 is a diagram showing a specific configuration example of the external device 8 and a processing procedure of the present invention.

FIG. 2 is a diagram showing a configuration example of the diagnosis target apparatus when the diagnosis target apparatus is a rotating machine.

FIG. 3 is a diagram showing an example of the overall configuration of a predicted-failure-evidence diagnosis apparatus 3 that performs diagnosis using the signal detected by the sensor in FIG. 2.

FIG. 4 is a diagram showing a schematic configuration of the design assistance apparatus.

FIG. 5 is a diagram showing a specific hardware configuration example of the reconfigurable processing device 5.

FIG. 6 is a flowchart showing a series of pieces of processing executed between the external device 8 and the reconfigurable processing device 5.

FIG. 7 is a diagram showing an example of a monitor display screen for mode selection.

FIG. 8 is a diagram showing an example of the selection screen of the preprocessing search reconfiguration information displayed on the monitor 89.

FIG. 9 is a diagram showing an example of a preprocessing procedure in processing step S101.

FIG. 10a is a diagram showing an example in which the acceleration signal properly falls within the measurement range.

FIG. 10b is a diagram showing an example in which the acceleration signal changes within a very narrow range of the measurement range.

FIG. 10c is a diagram showing an example in which the acceleration signal exceeds the measurement range.

FIG. 11a is a diagram showing a frequency spectrum of bearing vibration in a state where there is no influence of noise.

FIG. 11b shows a vibration spectrum measured by an inverter-driven motor.

FIG. 11c is a diagram showing characteristics of the bandpass filter BPF.

### DESCRIPTION OF EMBODIMENTS

Hereinafter, embodiments of the present invention will be described with reference to the drawings.

It should be noted that in the following description, a general predicted-failure-evidence diagnosis apparatus will be described first, and then a design assistance apparatus according to the present invention will be described.

### Embodiment

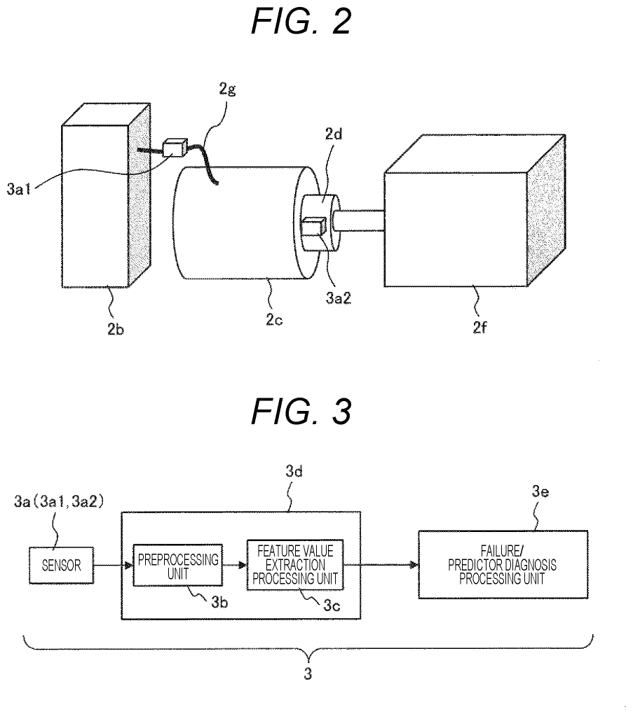

First, a general predicted-failure-evidence diagnosis apparatus will be described with reference to FIGS. 2 and 3.

The apparatus to be a diagnosis target by the predicted-failure-evidence diagnosis apparatus may be an appropriate one, but in the following description, a rotating machine is set as a target, and grasping an abnormality of a bearing or a coil of a motor, or a predictor thereof will be described as an example.

FIG. 2 is a diagram showing a configuration example of the diagnosis target apparatus when the diagnosis target apparatus is a rotating machine. In FIG. 2, the diagnosis target apparatus 2 includes a motor 2c, a power supply device 2b for supplying electric power to the motor 2c, a load device 2f to which motive power is supplied by the motor 2c to operate, a shaft and a bearing 2d provided between the motor 2c and the load device 2f, and a power cable 2g for supplying electric power to the motor.

In this case, the diagnosis target part is, for example, the bearing 2d, and an acceleration sensor 3a2 for catching the abnormality of the bearing 2d is provided here. In addition, the diagnosis target part is a motor coil, and the power cable 2g is provided with a current sensor 3a1 in order to grasp the abnormality of the motor coil (insulation abnormality or the like).

FIG. 3 is a diagram showing an example of the overall configuration of a predicted-failure-evidence diagnosis apparatus 3 that performs diagnosis using the signal detected by the sensor in FIG. 2. The predicted-failure-evidence diagnosis apparatus 3 includes, as the main components, a sensor 3a attached to a diagnosis target apparatus, a feature value detection apparatus 3d that extracts a feature value used for the predicted-failure-evidence diagnosis, and a failure/predictor diagnosis unit 3e that performs a predicted-failure-evidence diagnosis using the feature value.

The sensor 3a in FIG. 3 is the acceleration sensor 3a2 or the current sensor 3a1 in the example in FIG. 2.

The feature value extraction apparatus 3d in FIG. 3 includes a preprocessing unit 3b and a feature value extraction processing unit 3c, and extracts a feature value necessary for performing a failure/predictor diagnosis.

Of these, in the preprocessing unit 3b, performed is the processing of amplifying or attenuating the sensor signal to obtain the optimum signal strength for processing, of removing vibration or electrical signals emitted from other than the diagnosis target object that affects the feature value extraction processing, and of removing the influence of the operation section or the like in which the diagnosis accuracy decreases if the operation of the diagnosis target apparatus 2 is in a transient state and diagnosis is performed in this state section. The disturbances that adversely affect these pieces of feature value extraction processing are collectively referred to as noise.

The feature value extraction processing unit 3c extracts the feature value necessary for performing the failure/predictor diagnosis after performing the processing that removes the influence of these noises. The feature value extraction processing unit 3c performs appropriate feature value extraction processing on the signal after the preprocessing and provides the extracted feature value as an effective value. For example, when the feature value has a magnitude of a specific frequency included in the sensor signal, the feature value extraction processing unit 3c performs frequency transform processing to extract the magnitude of the specific frequency, and outputs the magnitude as an effective value.

The failure/predictor diagnosis unit 3e performs failure/predictor diagnosis processing using the feature value obtained by the feature value extraction apparatus 3d. It should be noted that various methods are known for achieving the failure/predictor diagnosis unit 3e, and the present invention itself is not an invention regarding a predicted-failure-evidence diagnosis method, and therefore the method for achieving the failure/predictor diagnosis unit 3e will not be described further.

In the predicted-failure-evidence diagnosis apparatus in FIG. 3, it is the execution of appropriate preprocessing that is important to improve the accuracy of the failure predictor. The feature value extraction processing of bearing abnormalities and the feature value extraction processing of insulation abnormalities have been developed based on data collected in simulated failure experiments or the like conducted in an ideal environment with little noise. Thus, there may be a case where the preprocessing unit 3b is provided by assuming noise in advance so as to obtain collected data in such an ideal environment, but it is not always possible to remove noise with the noise removal algorithm assumed at the actual diagnosis site. The feature value detection apparatus 3d outputs the feature value necessary for detecting an abnormal state. Therefore, even if an unexpected noise signal is included, it is difficult to notice it.

Therefore, it is the design assistance apparatus for the predicted-failure-evidence diagnosis apparatus according to the present invention that solves this problem. The design assistance apparatus is for optimizing the characteristics, functions, operations, and the like of the predicted-failure-evidence diagnosis apparatus 3, particularly of the portion of the feature value extraction apparatus 3d, the characteristics and the like optimized by the design assistance apparatus are transplanted to and reflected in the feature value extraction apparatus 3d of the predicted-failure-evidence diagnosis apparatus 3 and applied to the actual apparatus, and the predicted-failure-evidence diagnosis apparatus 3 after application executes abnormality predictor processing.

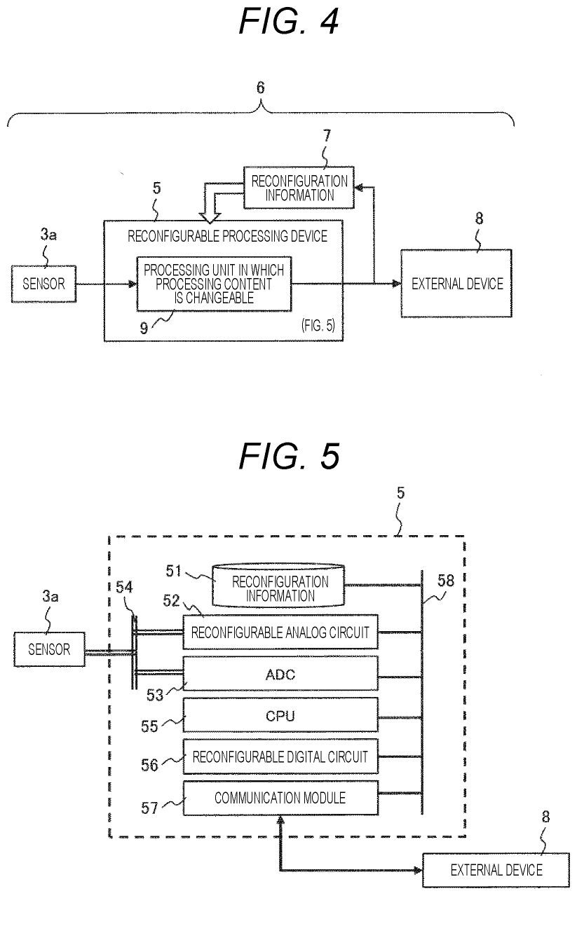

FIG. 4 is a diagram showing a schematic function of the design assistance apparatus. In FIG. 4, the design assistance apparatus 6 includes, as the main components, a sensor 3a attached to the diagnosis target apparatus, a reconfigurable processing device 5, and an external device 8. In addition, the reconfigurable processing device 5 is configured to include a processing unit in which the processing content is changeable 9.

In FIG. 4, the processing unit in which the processing content is changeable 9 has a function corresponding to the feature value extraction apparatus 3d in FIG. 3, and at the time of operating the design assistance apparatus 6, represents a preprocessing unit 3b and a feature value extraction processing unit 3c having appropriate characteristics and content. The external device 8 evaluates the feature value to be obtained by the preprocessing unit 3b and the feature value extraction processing unit 3c which have appropriate characteristics and content embodied by the processing unit in which the processing content is changeable 9, and as a result, the reconfiguration information 7, being the form in which the preprocessing unit 3b and the feature value extraction processing unit 3c should originally be, is obtained. Thereafter, the processing unit in which the processing content is changeable 9 is set as the pre-processing unit 3b and the feature value extraction processing unit 3c that reflect the reconfiguration information 7, and the characteristics and the like are reflected particularly in the feature value extraction apparatus 3d of the actual predicted-failure-evidence diagnosis apparatus 3.

FIG. 5 is a diagram showing a specific hardware configuration example of the reconfigurable processing device 5. The reconfigurable processing device 5 shown in this figure includes an analog signal processing section and a digital signal processing section.

Specifically, as an analog signal processing section, a reconfigurable analog circuit 52 and an analog-digital converter (ADC) 53 are included, and as a digital signal processing section, a storage unit 51 in which reconfiguration information is stored, a microcomputer (CPU) 55, a reconfigurable digital circuit 56, and a communication module 57 are included. The analog signals by these are connected by the analog signal bus 54, and the digital signals are connected by the digital signal bus 58, mutually enabling information exchange.

In addition, the digital signal is connected to the external device 8 from the digital signal bus 58 via the communication module.

With the configuration as shown in FIG. 5, changing the circuit configuration of the reconfigurable analog circuit 52 and the reconfigurable digital circuit 56 based on the reconfiguration information stored in the storage unit 51, or changing the processing program of the CPU 55 makes it possible to reconfigure the processing content of the reconfigurable processing device 5 as a whole.

It should be noted that examples of the specific elements and circuits for configuring the reconfigurable processing device 5 include a Programmable System-on-Chip as an LSI mounted with reconfigurable analog circuits and digital circuits and a CPU.

The reconfigurable analog circuit includes a plurality of built-in operational amplifiers, and its wiring is changed using the reconfiguration information (connection information) stored in the storage unit 51. Thus, changing the gain of the operational amplifier or changing the connection configuration of the operational amplifier to change the frequency characteristics of various filters such as a BPF and an LPF allows the analog signal processing to be customized. Changing the reconfiguration information also allows the analog circuit to be changed to analog signal processing of another function.

In addition, the digital circuit can also be customized by the same procedure, and the analog/digital circuit and the programs of the built-in CPU can be changed based on the reconfiguration information. In addition, examples of a reconfigurable LSI of a digital circuit also include a field-programmable gate array (FPGA) or the like. The built-in gate circuit connection can be changed based on the reconfiguration information.

It should be noted that not all reconfigurable analog circuits, reconfigurable digital circuits, and CPUs are required to configure the reconfigurable processing device 5. An analog signal processing circuit configured only with reconfigurable analog circuits and performed only with analog circuits may be configured, or the whole processing may be performed by only the CPU.

In addition, mounting the communication module 57 makes it possible to communicate with the external device 8 to obtain reconfiguration information, and to transmit the data collected from the sensor 3a, the processing result internally processed, and the like to the external device 8.

With this configuration, the reconfigurable processing device 5 shown in FIG. 4 can be achieved. It should be noted that in the above-described configuration, the arithmetic unit being the CPU outputs, to the outside by communication module, the feature value obtained by performing, on the data from the sensor, the preprocessing and the feature value extraction processing using a reconfigurable analog circuit and a reconfigurable digital circuit, stores the reconfiguration information obtained from the outside in the reconfiguration information database, and controls a series of pieces of processing that configure the reconfigurable analog circuit and the reconfigurable digital circuit according to the reconfiguration information.

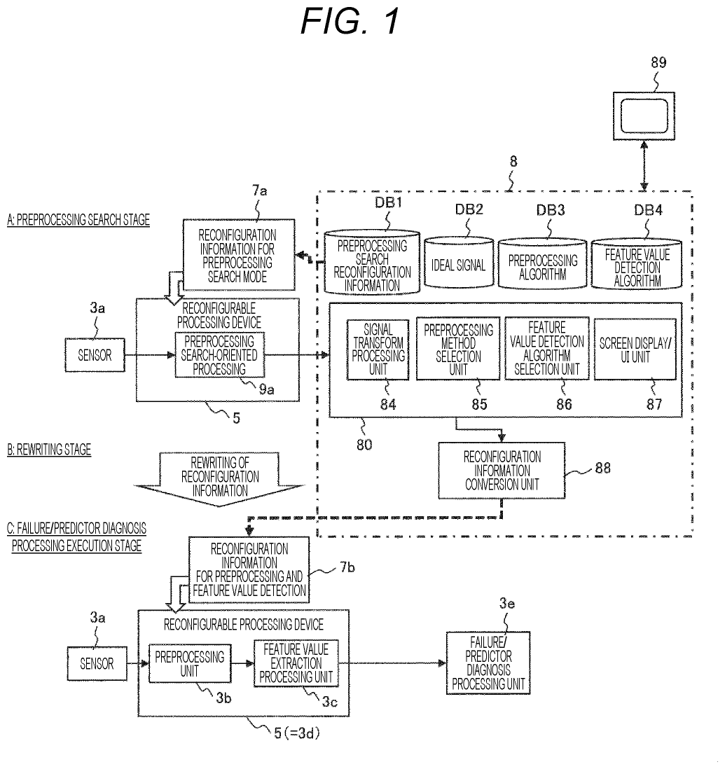

FIG. 1 is a diagram showing a specific configuration example of the external device 8 and a processing procedure of the present invention. First, a specific configuration example of the external device 8 will be described with reference to FIG. 1. The internal functions of the external device 8 are shown as blocks in FIG. 1, and can be represented by databases DB that store various pieces of data, a processing unit 80, and a reconfiguration information conversion unit 88.

In FIG. 1, the databases DB that store various pieces of data include a preprocessing search reconfiguration information database DB1 that stores preprocessing search reconfiguration information, an ideal signal database DB2 that stores an ideal signal, a preprocessing algorithm database DB3 that stores a preprocessing algorithm, and a feature value extraction algorithm database DB4 that stores a feature value extraction algorithm.

In addition, the processing unit 80 includes: a signal transform processing unit 84 for signal-converting and taking in information obtained from the reconfigurable processing device 5, or for signal-converting information created internally as preprocessing search reconfiguration information to provide as reconfiguration information 7a for a preprocessing search mode; a preprocessing method selection unit 85 for selecting a preprocessing algorithm stored in the preprocessing algorithm database DB3; a preprocessing method selection unit 85 for selecting the feature value extraction algorithm stored in the feature value extraction algorithm database DB4; and a screen display/UI unit 87 for displaying the halfway progress of processing, processing results, and the like on the monitor 89 to present them to the designer, or for reflecting the designer's instructions in the processing in the external device 8.

In addition, FIG. 1 describes the processing procedure of the present invention. The upper row in FIG. describes the processing in the preprocessing search stage A. In the preprocessing search stage A, the reconfigurable processing device 5 executes preprocessing search-oriented processing 9a using the data from the sensor 3a. The external device 8 obtains the result information on the preprocessing search-oriented processing 9a from the reconfigurable processing device 5 and presents the reconfiguration information to the reconfigurable processing device 5. The processing is repeatedly executed between the external device 8 and the reconfigurable processing device 5 until the information on the optimum preprocessing configuration is obtained. It should be noted that at the time of completion of the preprocessing search-oriented processing, the reconfiguration information on the preprocessing unit 3b and the feature value extraction processing unit 3c is obtained.

The internal processing of the external device 8 obtains the information from the reconfigurable processing device 5 in the signal transform processing unit 84, sequentially selects and changes the preprocessing algorithm stored in the preprocessing algorithm database DB3 or the feature value algorithm stored in the feature value extraction algorithm database DB4 to create reconfiguration information, sets the reconfiguration information to the reconfigurable processing device 5, and repeatedly executes processing until the re-input information from the reconfigurable processing device 5 reaches the ideal signal stored in the ideal signal database DB2. In addition, the halfway progress of the reconfiguration and the final result are displayed on the monitor as appropriate.

The middle row in FIG. 1 describes a rewriting stage B. At this stage, the ideal reconfiguration information is obtained by the internal processing of the external device 8. The ideal reconfiguration information is converted by the reconfiguration information conversion unit 88, and is set to the preprocessing unit 3b and the feature value extraction unit 3c of the reconfigurable processing device 5 as the reconfiguration information 7b for preprocessing and feature value detection.

The lower row in FIG. 1 describes the failure/predictor diagnosis processing execution stage C. At this stage, the external device 8 is separated from the reconfigurable processing device 5, and the reconfigurable processing device 5 is connected to the failure/predictor diagnosis processing unit 3e to function as the feature value detection apparatus 3d.

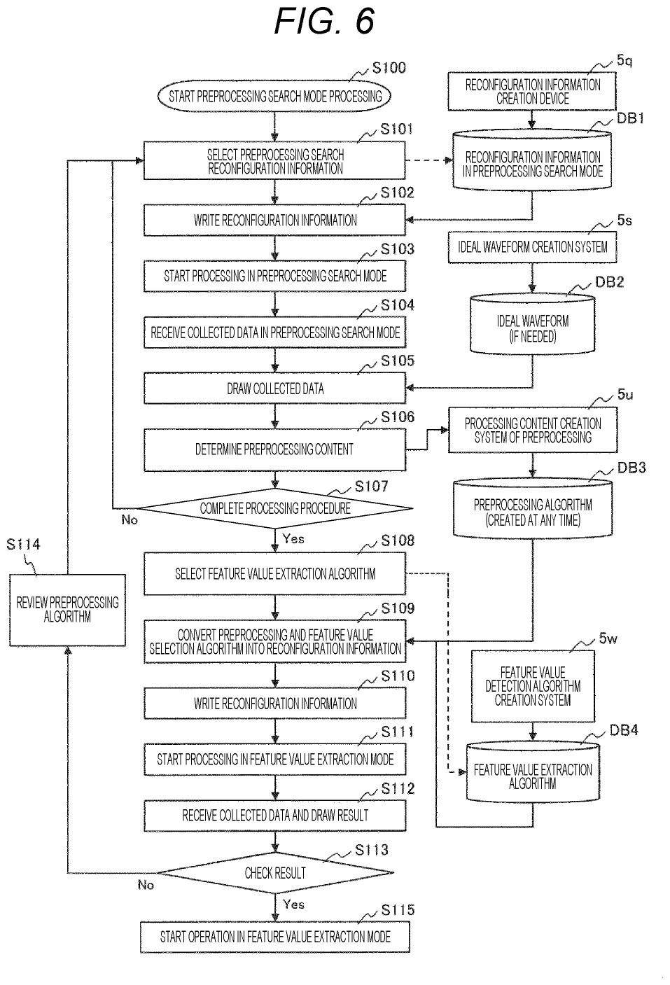

A flowchart showing a series of pieces of processing executed between the external device 8 and the reconfigurable processing device 5 is shown in FIG. 6.

FIG. 6 shows a flow in the preprocessing search mode, in this, processing steps S100 to S107 show the preprocessing portion, and processing steps S108 to S115 in the latter half show the portion of the processing for determining the feature value and the consistency of the overall processing.

In the following, a processing procedure for determining the processing contents and parameters of the preprocessing will be described with reference to FIG. 6. In the present processing procedure, a preprocessing method for feature value extraction processing for the purpose of failure/predictor diagnosis of a bearing will be described.

In the following, for convenience of description, the processing procedure shown in FIG. 9 is assumed as the preprocessing procedure in the preprocessing unit 3b. Here, the preprocessing procedure in the preprocessing unit 3b is assumed to include: first, the processing by the amplifier Amp1 that sets the parameters and the gain to adjust the sensor signal 11a to the optimum signal level; the processing by the bandpass filter BPF that sets parameters, filter types, and frequency bands to remove the effects of noise components other than bearing vibration; and lastly, the processing by the amplifier Amp2 that sets the parameters and the gain to increase the sensor signal 11a to the appropriate signal level because the signal level may decrease due to the bandpass filter BPF transmission. After these pieces of preprocessing are appropriately performed, the feature value detection processing 11e is executed.

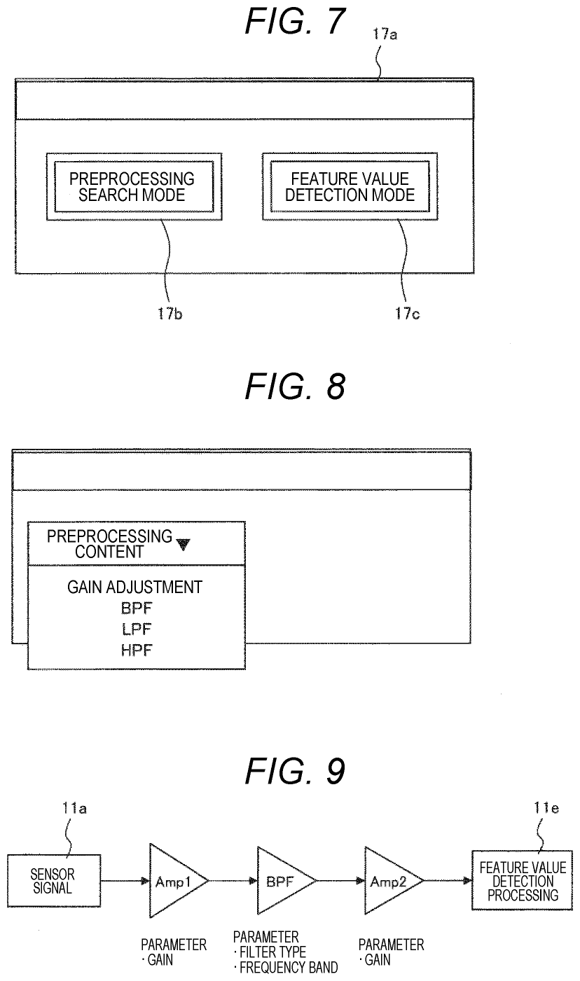

In the first processing step S100 of the flowchart in FIG. 6, the preprocessing search mode processing is started. Specifically, for example, at the time of starting the application of the external device 8, displaying a monitor display screen 17a for mode selection as shown in FIG. 7 on the screen of the monitor 89 connected to the external device 8 and pressing the preprocessing search mode or the start button 17b for the preprocessing search mode starts the search for the preprocessing method. It should be noted that FIG. 7 shows an example of a monitor display screen for mode selection. The screen may additionally include a feature value detection mode or a feature value detection mode start button 17c.

In the next processing step S101, preprocessing search reconfiguration information is selected. FIG. 8 is an example of the selection screen of the preprocessing search reconfiguration information displayed on the monitor 89. As the preprocessing contents in the preprocessing unit configuration in FIG. 9, a gain adjustment work, a filter type, and the like are displayed, and appropriate ones can be selected according to the configuration of the preprocessing unit.

The processing here will be described with reference to the example of the preprocessing shown in FIG. 9. First, an appropriate gain of the amplifier Amp1 is searched. The acceleration sensor 3a2 for diagnosing the bearing is preferably installed near the bearing, but if the place where the acceleration sensor 3a2 can be installed is not near the bearing, it may be necessary to install the acceleration sensor 3a2 at a remote place. In this case, the vibration is attenuated and becomes a small signal as compared with that near the bearing. In addition, depending on the shape and model of the bearing, there exist also bearings that generate large vibration even in a normal state. If the vibration level is known in advance, it can be determined in advance, but in many cases it is usually not known until the site is visited.

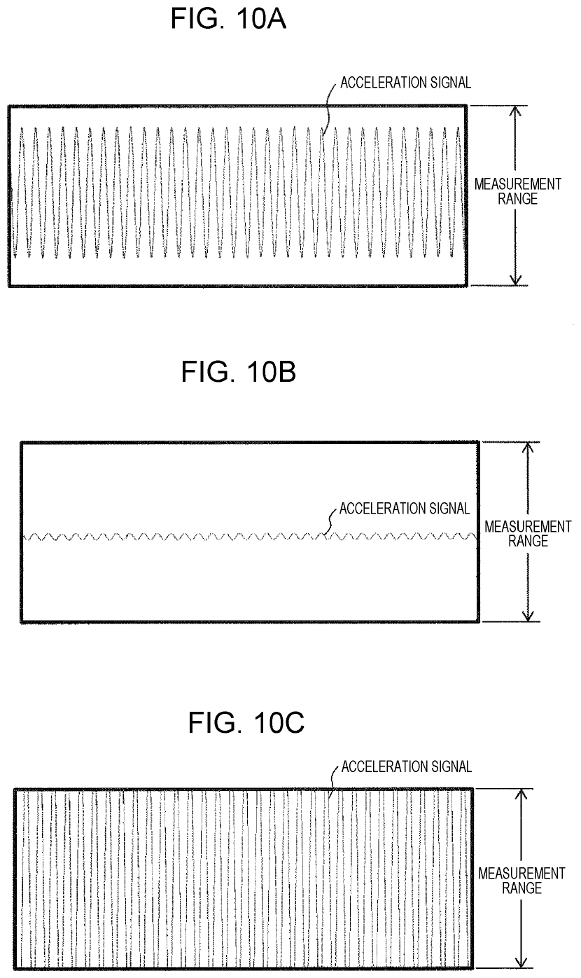

Therefore, when the acceleration signal properly falls within the measurement range as shown in FIG. 10a, the acceleration signal has an ideal and good waveform, but the acceleration signal may change within a very narrow range of the measurement range as shown in FIG. 10b, and in contrast to this, the acceleration signal may exceed the measurement range as shown in FIG. 10c. When the magnitude of the change is small, the quantization error becomes large when the analog signal is finally converted into the digital signal, and sufficient accuracy cannot be obtained, and when the measurement range is exceeded, it becomes difficult to grasp the accurate waveform. Therefore, the proper gain of the amplifier Amp1 has to be determined so that the acceleration signal falls within the proper range of the measurement range.

In order to search for an appropriate gain of the amplifier Amp1, the gain of the amplifier Amp1 has only to be set to a temporary value, and its output has only to be AD converted and evaluated. Therefore, regarding the reconfiguration information on the preprocessing search mode, a processing configuration that sets a temporary gain in the amplifier Amp1 to AD-convert and observe the output result has only to be created in advance by the reconfiguration information creation device 5q, and the reconfiguration information has only to be selected. The reconfiguration information on the preprocessing search mode created in advance by the reconfiguration information creation device 5q is stored in the database DB1.

In the next processing step S102, reconfiguration information is written. The reconfiguration information selected from the database DB1 is written in the reconfigurable processing device 5 and is changed by a device that performs processing of directly AD converting and observing the sensor signal 9a in FIG. 9.

In the next processing step S103, the operation of the reconfigurable processing device 5 whose processing content has been changed is started, the processing result is received in the processing step S104, and the collected data is drawn in the processing step S105.

When the drawing result is the result in FIG. 10a, the temporary gain set in the amplifier Amp1 can be determined as an appropriate gain, but when the results as shown in FIG. 10b and FIG. 10c are drawn, the gain has only to be changed so as to be equivalent to that in FIG. 10a. In the processing step S106, the gain determined to be appropriate is determined as the content of the preprocessing, and the content of the preprocessing thus determined (the gain of the amplifier Amp1 this time) is registered as a preprocessing algorithm in the database DB3 via the processing content creation system of the preprocessing. It should be noted that when the collected data is drawn in processing step S105, the ideal waveform created by the ideal waveform creation system and stored in the database DB2 is appropriately displayed, thereby allowing to make the display easily understood by the designer.

After the amplifier Amp1, it is necessary to determine the characteristics of the bandpass filter BPF that removes the effects of noise components other than the bearing vibration, so that the process returns from processing step S107 to processing step S101 to repeat the search for the preprocessing method for determining the characteristics of the bandpass filter BPF.

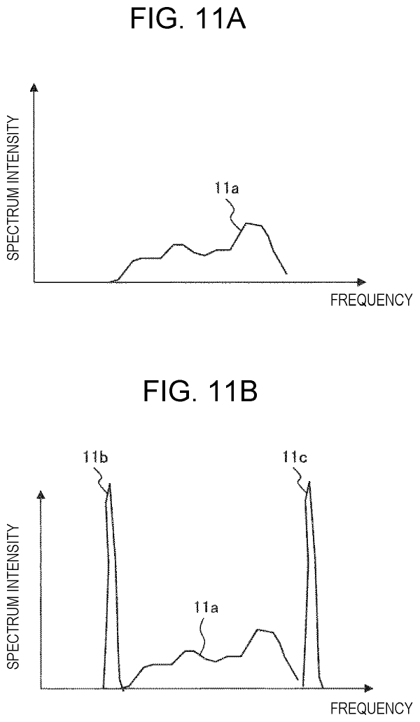

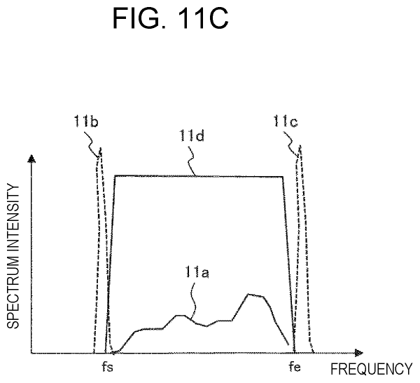

The bandpass filter BPF is a filter used to eliminate the effect of vibration noise originating from parts other than bearings. The relationship between the frequency and the spectrum intensity in the bandpass filter BPF will be described with reference to FIGS. 11a, 11b, and 11c.

First, FIG. 11a shows the frequency spectrum of the bearing vibration without the influence of noise. The characteristic 11a is a vibration spectrum caused by the bearing and has an ideal waveform.

FIG. 11b shows a vibration spectrum measured by an inverter-driven motor. The characteristics 11b and 11c are vibration spectra that appear when the coil vibrates due to the influence of switching of the inverter. The vibration spectra 11b and 11c are vibrations not related to bearings, and vibrations affecting the failure/predictor diagnosis accuracy. This vibration depends on the switching frequency of the inverter, and the degree to which the coil vibrates due to the switching signal also differs depending on the model, so that this vibration is difficult to know in advance. Thus, it is necessary to observe the effect of this switching noise and search for a preprocessing method that removes the effect.

Regarding the processing configuration for preprocessing search used here, the processing configuration used in the amplification determination of the amplifier Amp1 can be used as it is. The value of the acceleration sensor is collected by the processing configuration in which the gain of the amplifier Amp1 is set appropriately, and the signal transform processing unit 84 in FIG. 1 performs frequency transform processing such as FFT. This displays the frequency spectrum shown in FIG. 11b. From this, as shown in FIG. 11c, a bandpass filter BPF that has the characteristic 11d of the bandpass filter BPF capable of removing the characteristics 11b and 11c (region characteristic such that the passband is fs to fe) has only to be created by the processing content creation system 5u of the preprocessing in FIG. 1 and has only to be registered in the preprocessing algorithm database DB3.

Lastly, the gain of the amplifier Amp2 is determined. The purpose of the amplifier Amp2 is to cope with the case where the spectrum characteristics 11b and 11c are eliminated by passing through the bandpass filter BPF and the signal amplitude is reduced. This state is a state measured as a minute signal, as shown in FIG. 10b. Thus, it is necessary to check what the state of the signal after passing through the bandpass filter BPF is. This can be achieved by creating, in the reconfiguration information creation device 5q in FIG. 1 as preprocessing search reconfiguration information, a processing content such as AD converting and outputting the analog signal after passing through the amplifier Amp1 and the bandpass filter BPF whose frequency characteristic is determined. Since the method for determining the gain of the amplifier Amp2 is the same as that of the amplifier Amp1, the method will not be described.

Next, in processing step S108 in FIG. 6, the feature value selection algorithm database DB4 is accessed using the feature value detection algorithm selection unit 86, and the feature value selection algorithm for bearing diagnosis is selected. The processing content (amplifier Amp1→bandpass filter BPF→amplifier Amp2) in the preprocessing unit 3b and the selected feature value selection algorithm are converted into reconfiguration information in processing step S109. This conversion is performed by the reconfiguration information conversion unit 88 in FIG. 1.

In processing step S110, the converted reconfiguration information is written to the reconfigurable processing device. This writing processing is the rewriting stage B in FIG. 1. Thus, the feature value extraction mode for executing the preprocessing unit 3b and the feature value extraction processing unit 3c can be executed.

In processing step S111, the processing is started in the feature value detection mode, in processing step S112, the collected data is received and the result is drawn, and in processing step S113, it is determined whether the processing is normally executed. If the processing is not normally executed, in processing step S114, the preprocessing algorithm is reviewed.

If it is checked that the normal processing is performed, in processing step S115, the operation in the feature value extraction mode is started. At this time, the extracted data on the feature value is sent not to the external device 8 but to the failure/predictor diagnosis processing unit 3e. Thus, the failure/predictor diagnosis is performed based on the extracted feature value.

According to the present embodiment, it is possible to select the optimum preprocessing method while checking the characteristics of the collected data before the preprocessing of the feature value extraction such as the gain of the amplifier and the filtering processing.

It should be noted that a series of design work using the external device 8 shown in FIG. 1 may be automatically executed by a computer, or may progress while the designer conducts checking and correction work one by one via the monitor 89.

### REFERENCE SIGNS LIST

3 predicted-failure-evidence diagnosis processing apparatus
3a sensor
3b preprocessing unit
3c feature value extraction processing unit
3d feature value extraction apparatus
5 reconfigurable processing device
6 design assistance apparatus
8 external device
9 processing unit in which the processing content is changeable
80 processing unit
84 signal transform processing unit
85 preprocessing method selection unit
86 feature value detection algorithm selection unit
87 screen display/UI unit
88 reconfiguration information conversion unit
89 monitor
DB1 preprocessing search reconfiguration information database
DB2 ideal signal database
DB3 preprocessing algorithm database
DB4 feature value detection database

1. A feature value extraction apparatus configured to obtain data from a sensor attached to a diagnosis target apparatus to output a feature value after preprocessing, the feature value extraction apparatus comprising:
a reconfigurable circuit configured to input data from the sensor;
an arithmetic unit;
a reconfiguration information database configured to store reconfigured information; and
a communication module for external connection,
wherein the arithmetic unit outputs, to an outside by communication module, a feature value obtained by performing, on data from the sensor, preprocessing and feature value extraction processing using the reconfigurable circuit, stores reconfiguration information obtained from an outside in the reconfiguration information database, and configures the reconfigurable circuit according to the reconfiguration information.

2. A predicted-failure-evidence diagnosis apparatus comprising a predicted-failure-evidence diagnosis processing unit configured to diagnose the diagnosis target apparatus using a feature value from the feature value extraction apparatus according to claim 1.

3. A design assistance apparatus comprising:
determining configuration of the reconfigurable circuit using a feature value from the feature value extraction apparatus according to claim 1; and
sending the configuration to the feature value extraction apparatus as the reconfiguration information via the communication module.

4. The design assistance apparatus according to claim 3,
wherein the reconfigurable circuit performs noise removal processing of data from a sensor attached to a diagnosis target apparatus, the design assistance apparatus further comprising:
a checking means configured to check an effect of the noise removal processing;
an optimum algorithm selection unit configured to select an optimum noise removal algorithm;
a reconfiguration information creation unit configured to generate reconfiguration information on the noise removal processing using the optimum noise removal algorithm; and
a transmission unit configured to transmit the reconfiguration information to the feature value extraction apparatus.

5. The design assistance apparatus according to claim 3, further comprising a monitor,
wherein the monitor displays processing content in the feature value extraction apparatus.

6. A predicted-failure-evidence diagnosis operation method comprising:
connecting, to a design assistance apparatus, a feature value extraction apparatus including a reconfigurable circuit configured to input data from a sensor attached to a diagnosis target apparatus, and a reconfiguration information database configured to store reconfiguration information, the feature value extraction apparatus configured to change a configuration of the reconfigurable circuit according to the reconfiguration information;
in the design assistance apparatus, determining a configuration of the reconfigurable circuit using a feature value from the feature value extraction apparatus, sending the configuration to the feature value extraction apparatus as the reconfiguration information, and storing the configuration in a reconfiguration information database; and
separating the feature value extraction apparatus from the design assistance apparatus, and connecting to a predicted-failure-evidence diagnosis processing apparatus configured to diagnose the diagnosis target apparatus using a feature value from the feature value extraction apparatus instead.

7. The design assistance apparatus according to claim 4, further comprising a monitor,
wherein the monitor displays processing content in the feature value extraction apparatus.
